(19) United States
(12) Patent Application Publication
(10) Pub. No.: US 2006/0245137 A1
(43) Pub. Date: Nov. 2, 2006

(54) Backplane connectors

(75) Inventors: James J. David, Mechanicsburg, PA (US); Dana J. Bergey, Hershey, PA (US)

Correspondence Address: WOODCOCK WASHBURN, LLP, ONE LIBERTY PLACE - 46TH FLOOR, PHILADELPHIA, PA, 19103, US

(73) Assignee: FCI Americas Technology, Inc., Reno, NV (US)

(21) Appl. No.: 11/348,130

(22) Filed: Feb. 6, 2006

Related U.S. Application Data
(60) Provisional application No. 60/676,571, filed on Apr. 29, 2005.

(51) Int. Cl. H02H 9/06

(52) U.S. Cl. 361/118

(57) ABSTRACT

Electrical connectors having a first differential signal pair of electrical contacts edge-coupled along a first direction, a second differential signal pair of electrical contacts edge-coupled along the first direction, and a ground plate disposed between the first and second differential signal pairs are disclosed. The ground plate extends along a second direction that is different from the first direction.

### CROSS-REFERENCE TO RELATED APPLICATIONS

This application claims benefit under 35 U.S.C. §119(e) of provisional U.S. patent application No. 60/676,571, filed Apr. 29, 2005.

The subject matter disclosed and claimed herein is related to the subject matter disclosed and claimed in U.S. patent application Ser. No. 10/294,966, filed Nov. 14, 2002, which is a continuation-in-part of U.S. patent applications Ser. No. 09/990,794, filed Nov. 14, 2001, now U.S. Pat. No. 6,692,272, and Ser. No. 10/155,786, filed May 24, 2002, now U.S. Pat. No. 6,652,318. The subject matter disclosed and claimed herein is related to the subject matter disclosed and claimed in U.S. patent application Ser. No. 10/634,547, filed Aug. 5, 2003, and in U.S. patent application Ser. No. 10/294,966, filed Nov. 14, 2002.

The contents of each of the above-referenced U.S. patents and patent applications is herein incorporated by reference in its entirety.

### FIELD OF THE INVENTION

Generally, the invention relates to electrical connectors. More particularly, the invention relates to electrical connectors having intermediate ground plates disposed between adjacent differential signal pairs of electrical contacts.

### BACKGROUND OF THE INVENTION

Electrical connectors provide signal connections between electronic devices using signal contacts. Often, the signal contacts are so closely spaced that undesirable interference, or “cross talk,” occurs between adjacent signal contacts. As used herein, the term “adjacent” refers to contacts (or rows or columns) that are next to one another. Cross talk occurs when one signal contact induces electrical interference in an adjacent signal contact due to intermingling electrical fields, thereby compromising signal integrity. With electronic device miniaturization and high speed, high signal integrity electronic communications becoming more prevalent, the reduction of cross talk becomes a significant factor in connector design.

One commonly used technique for reducing cross talk is to position separate electrical shields, in the form of metallic plates, for example, between adjacent signal contacts. The shields act to block cross talk between the signal contacts by blocking the intermingling of the electric fields produced by the contacts.

Frequently, the contacts are often arranged in linear arrays, such as columns or rows. Such contact arrangements frequently include ground contacts are disposed between adjacent signal pairs, in the so-called signal-signal-ground arrangement. The ground contacts serve to block cross-talk between adjacent pairs disposed in the same array by blocking the intermingling of the electric fields produced by the respective pairs.

Though such ground contacts serve to block cross-talk, they also reduce the signal contact density of the connector (i.e., the number of signal contacts the connector has per unit area). It would be desirable, therefore, if connectors were available that include a grounding structure that blocks cross-talk between adjacent signal pairs, and also enables the signal contact density of the connector to be increased.

### SUMMARY OF THE INVENTION

An electrical connector according to the invention may include a lead frame assembly having a differential signal pair of electrical contacts and a housing that contains the lead frame assembly. The differential signal pairs may be disposed along a first direction, such as along a contact column, for example, and may be edge-coupled.

A ground plate assembly may surround the differential signal pair, and may include a plurality of ground plates, each of which is adjacent to at least one of the electrical contacts that form the differential signal pair. The ground plate assembly may shield the first differential signal pair from electrical interference from an adjacent differential signal pair, and may shield the adjacent differential signal pair from electrical interference from the first differential signal pair. The adjacent differential signal pair may be disposed along the first contact column, or along an adjacent contact column.

An intermediate ground plate may be disposed between first and second differential signal pairs, and may extend along a direction that is different from the direction along which the pairs are edge-coupled. That is, the intermediate ground plate may extend along a direction that is at a non-zero angle to the direction along which the pairs are edge-coupled. One or more lateral ground plates may extend along the direction along which the pairs are edge-coupled. The lateral ground plates may be in electrical contact with the intermediate ground plate. At least one of the differential signal pairs may be disposed between the lateral ground plates.

An end ground plate may also be disposed adjacent to one of the differential signal pairs, extending along a direction that is different from the direction along which the pairs are edge-coupled. One of the differential signal pairs may be disposed between the intermediate ground plate, the lateral ground plates, and the end ground plate. Thus, the ground plates, in combination, may surround the differential signal pair.

### BRIEF DESCRIPTION OF THE DRAWINGS

FIG. 1 depicts an example embodiment of an electrical connector assembly.

FIG. 2 depicts an example embodiment of a header connector.

FIG. 3 depicts an example embodiment of an insert molded leadframe assembly.

FIGS. 4A and 4B depict an example embodiment of a receptacle connector.

FIG. 5 depicts an example arrangement of electrical contacts wherein ground contacts are disposed between adjacent signal pairs.

FIG. 6 depicts an example arrangement of electrical contacts according to the invention.

FIG. 7 depicts a second example arrangement of electrical contacts according to the invention.

FIG. 8 depicts a third example arrangement of electrical contacts according to the invention.

### DETAILED DESCRIPTION OF ILLUSTRATIVE EMBODIMENTS

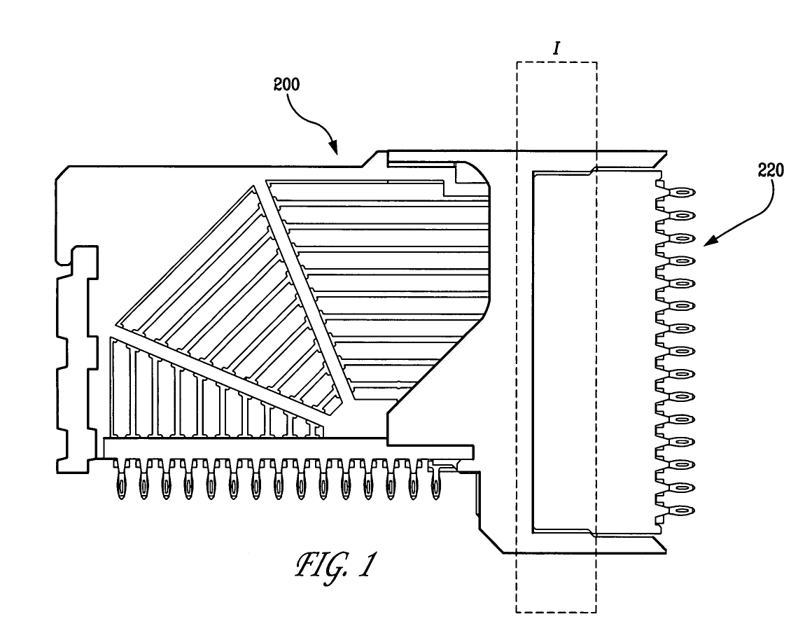

FIG. 1 depicts a side view of an example embodiment of an electrical connector comprising a header connector 200 and a receptacle connector 220. A mating interface area is designated generally with the reference I and refers to the mating interface between the header connector 200 and the receptacle connector 220.

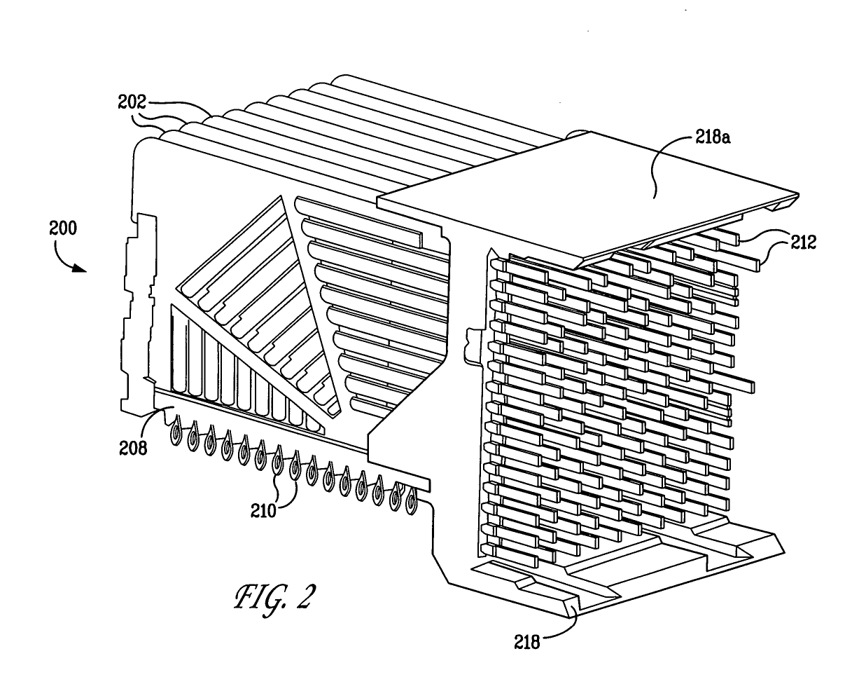

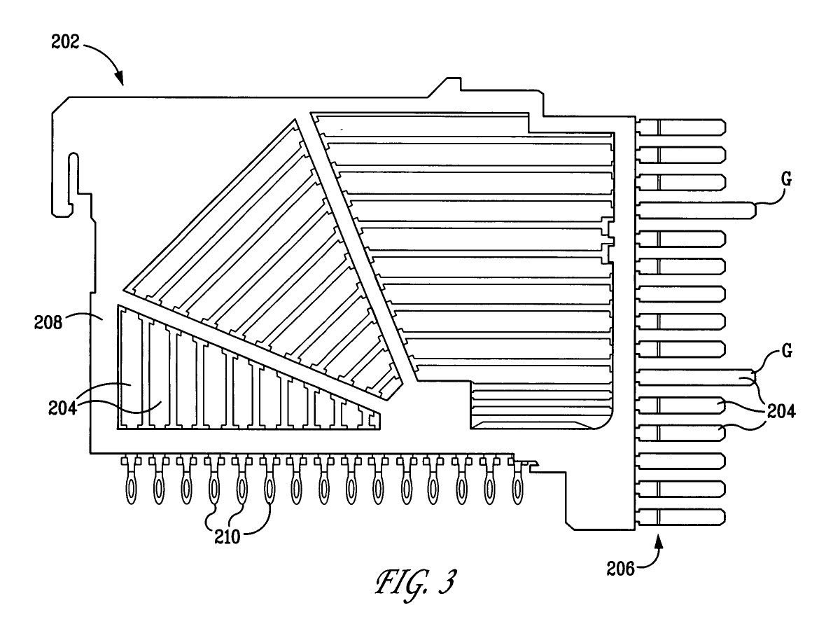

FIG. 2 depicts an example embodiment of a header connector 200. As shown, the header connector 200 may include a plurality of insert molded leadframe assemblies (IMLAs) 202. An IMLA 202, an example embodiment of which is depicted in FIG. 3, may include a contact set 206 of electrically conductive contacts 204, and a frame 208 through which the contacts 204 at least partially extend. An IMLA 202 may be adapted for use, without modification, for single-ended signaling, differential signaling, or a combination of single-ended signaling and differential signaling. That is, an IMLA 202 may be adapted such that each contact 204 may be selectively designated as a ground contact, a single-ended signal conductor, or one of a differential signal pair of signal conductors. The terminal ends of certain ground contacts G may be extended beyond the terminal ends of the other contacts. Thus, the ground contacts G having extended terminal ends may mate with complementary receptacle contacts before any of the signal contacts mates.

As shown, in FIG. 2, the IMLAs may be arranged such that contact sets 206 form contact columns, though it should be understood that the IMLAs could be arranged such that the contact sets are contact rows. Also, though the header connector 200 is depicted with 150 contacts (i.e., 10 IMLAs with 15 contacts per IMLA), it should be understood that an IMLA may include any desired number of contacts and a connector may include any number of IMLAs. For example, IMLAs having 12 or 9 electrical contacts are also contemplated. A connector, therefore, may include any number of contacts.

The IMLA 202 may include an electrically insulating leadframe 208 through which the contacts extend. Preferably, each leadframe 208 is made of a dielectric material such as a plastic, and is constructed from as little material as possible. Otherwise, the connector is air-filled. That is, the contacts may be insulated from one another using air as a second dielectric. The use of air provides for a decrease in crosstalk and for a low-weight connector (as compared to a connector that uses a heavier dielectric material throughout).

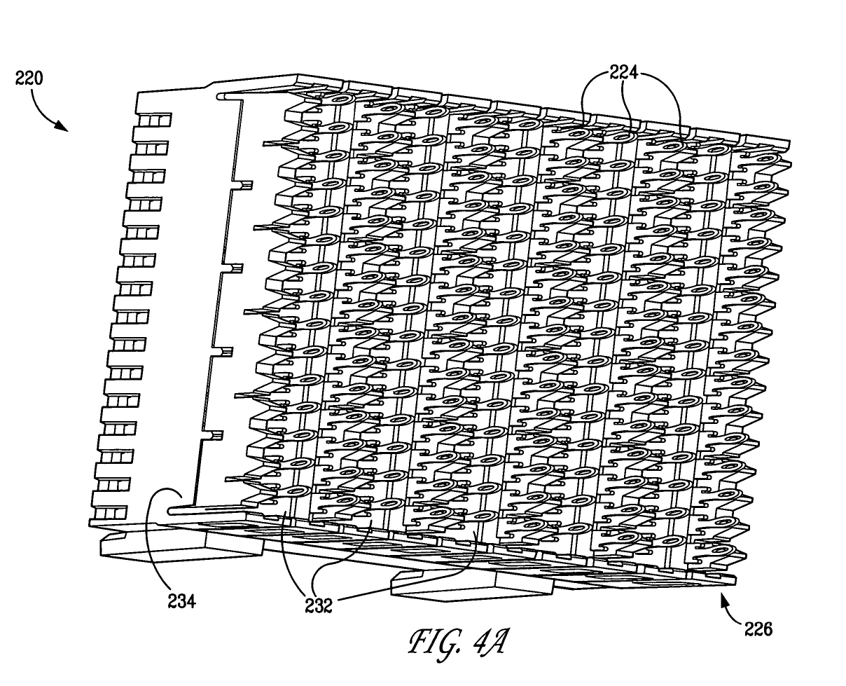

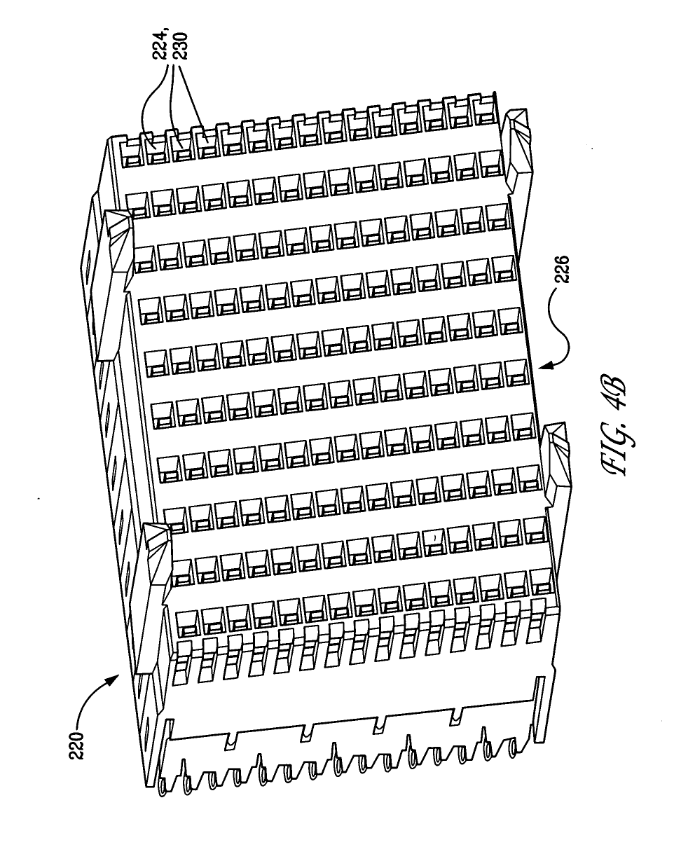

The contacts 204 include terminal ends 210 for engagement with a circuit board. Preferably, the terminal ends are compliant terminal ends, though it should be understood that the terminals ends could be press-fit or any surface-mount or through-mount terminal ends. The contacts also include mating ends 212 for engagement with complementary receptacle contacts (described below in connection with FIGS. 4A and 4B). As shown in FIG. 2, the header connector may have a housing 214 that includes a pair of end walls 218A, 218B.

Though the header connector 200 depicted in FIG. 2 is shown as a right-angle connector, it should be understood that a connector according to the invention may be any style connector, such as a mezzanine connector, for example. That is, an appropriate header connector may be designed for any type connector.

FIGS. 4A and 4B depict an example embodiment of a receptacle connector 220. FIG. 4A represents a view showing a terminal end face and FIG. 4B is a view showing a receptacle end face of a receptacle connector 220. The receptacle connector 220 includes a plurality of receptacle contacts 224, each of which is adapted to receive a respective mating end 212 of a complementary contact 204 (see FIG. 2). Further, the receptacle contacts 224 are in an arrangement that is complementary to the arrangement of the mating ends 212. Thus, the mating ends 212 may be received by the receptacle contacts 224 upon mating of the assemblies. Preferably, to complement the arrangement of the mating ends 212, the receptacle contacts 224 are arranged to form contact sets 226. Again, though the receptacle connector 220 is depicted with 150 contacts (i.e., 15 contacts per column), it should be understood that a connector may include any number of contacts.

Each receptacle contact 224 has a mating end 230, for receiving a mating end 212 of a complementary header contact 204, and a terminal end 232 for engagement with a circuit board. Preferably, the terminal ends 232 are compliant terminal ends, though it should be understood that the terminals ends could be press-fit, balls, or any surface-mount or through-mount terminal ends. A housing 234 is also preferably provided to position and retain the IMLAs relative to one another.

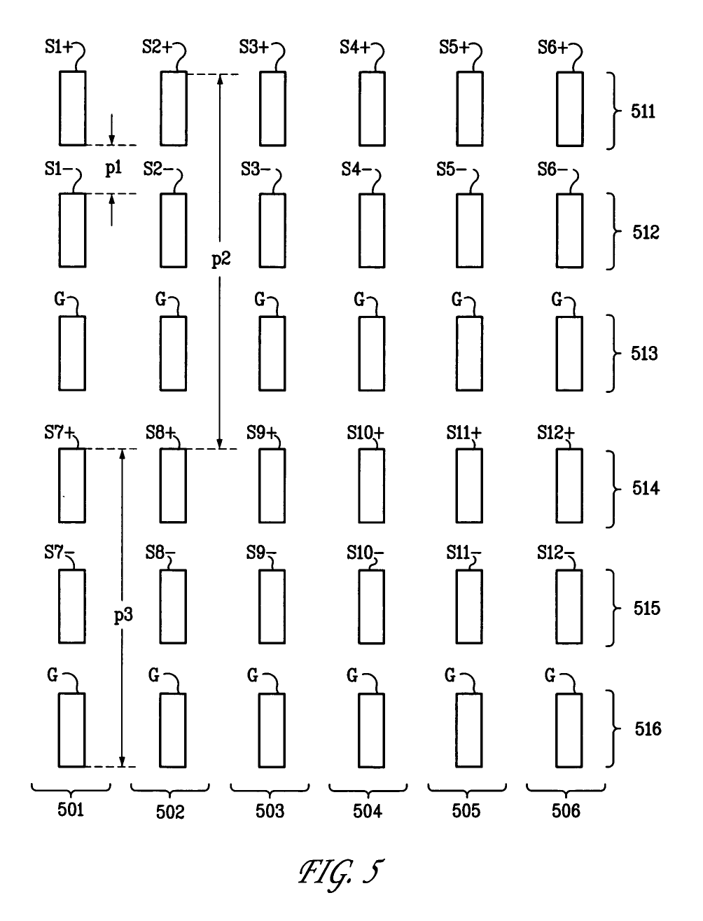

FIG. 5 depicts an example arrangement of electrical contacts wherein ground contacts are disposed between adjacent signal pairs. As shown, the contacts are arranged into a plurality of column-based differential signal pairs. That is, the differential signal pairs extend along contact columns. (As used herein, a “column” refers to the direction along which the contacts are edge coupled. A “row” is perpendicular to a column.) Also, as shown, the signal pairs may comprise signal contacts that are edge-coupled along a first direction, such as along the length of the contact column, for example.

As shown, each column 501-506 comprises, in order from top to bottom, a first differential signal pair, a first ground conductor, a second differential signal pair, and a second ground conductor. As can be seen, column 501, for example, comprises a first differential signal pair comprising signal conductors S1+ and S1−, a first ground conductor G, a second differential signal pair comprising signal conductors S7+ and S7−, and a second ground conductor G. Each of rows 513 and 516 comprises a plurality of ground conductors G. The row of ground conductors 513 limits cross talk between the signal pairs in rows 511/512 and the signal pairs in rows 514/515.

Contacts S1+ and S1−, for example, may be separated along the contact column by a gap having a gap width p1. Though every signal pair shown in FIG. 5 appears to have the same gap width, it should be understood that the gap widths for different pairs need not be the same. Also, though the distance between signal contacts and ground contacts along the column also appears to be the same (i.e., p1), it should be understood that the distance between signal contacts and ground contacts need not be the same.

Differential signal pair S1+/S1−, for example, may be separated along the contact column from differential signal pair S7+/S7− by a distance p2. As discussed below, the invention enables the distance between signal pairs to be reduced.

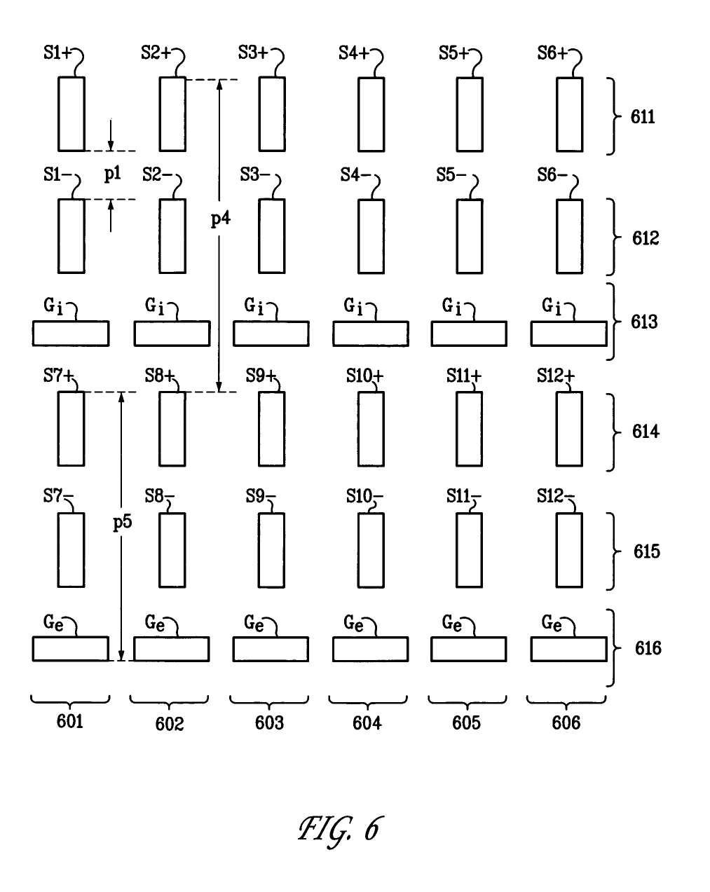

FIG. 6 depicts an example arrangement of electrical contacts according to the invention. As shown, each column 601-606 comprises a respective first differential signal pair, an intermediate ground plate, a second differential signal pair, and an end ground plate. Column 601, for example, comprises a first differential signal pair comprising signal conductors S1+ and S1−, an intermediate ground plate Gᵢ, a second differential signal pair comprising signal conductors S7+ and S7−, and an end ground plate Gₑ. The intermediate ground plates Gᵢ limit cross talk between the signal pairs in rows 611/612 and the signal pairs in rows 614/615. The end ground plates Gₑ limit interference with the signaling in the signal pairs in rows 614/615.

As shown, the signal pairs may comprise signal contacts that are edge-coupled along a first direction, such as along the length of the contact column, for example. According to an aspect of the invention, the ground plates Gᵢ and Gₑ extend along directions that are at a non-zero angle to the direction along which the adjacent signal contacts extend. As shown, the ground plates Gᵢ and Gₑ extend along a direction that is generally transverse to the direction along which the signal conductors extend. It should be understood, however, that the direction along which the ground plates Gᵢ and Gₑ extend may be at any non-zero angle to the direction along which the signal contacts extend. It should also be understood that different ground plates may form different angles with the direction along which the signal contacts extend.

As in the arrangement depicted in FIG. 5, contacts S1+ and S1−, for example, may be separated along the contact column by a gap having a gap width p1 (compare FIG. 5). Though every signal pair shown in FIG. 6 appears to have the same gap width, it should be understood that the gap widths for different pairs need not be the same. Also, though the distance between signal contacts and ground contacts along the column also appears to be the same (i.e., p1), it should be understood that the distance between signal contacts and ground contacts need not be the same.

By contrast with the arrangement depicted in FIG. 5, however, differential signal pair S1+/S1−, for example, may be separated along the contact column from differential signal pair S7+/S7− by a distance p4. Because the intermediate ground plate Gᵢ between contacts S1+ and S1− is at an angle to the direction along which the signal pairs are edge-coupled, the distance p3 may be less than the distance p2 shown in FIG. 5. Similarly, because the end ground plate Gₑ adjacent to contact S7− is at an angle to the direction along which the signal pairs are edge-coupled, the distance p5 may be less than the distance p3 shown in FIG. 5. Consequently, a connector having a contact arrangement as depicted in FIG. 6 may have a greater signal contact density that a connector having a contact arrangement as depicted in FIG. 5.

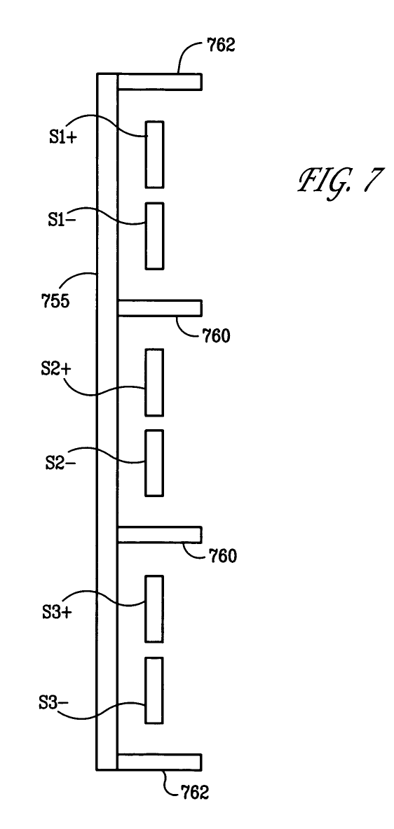

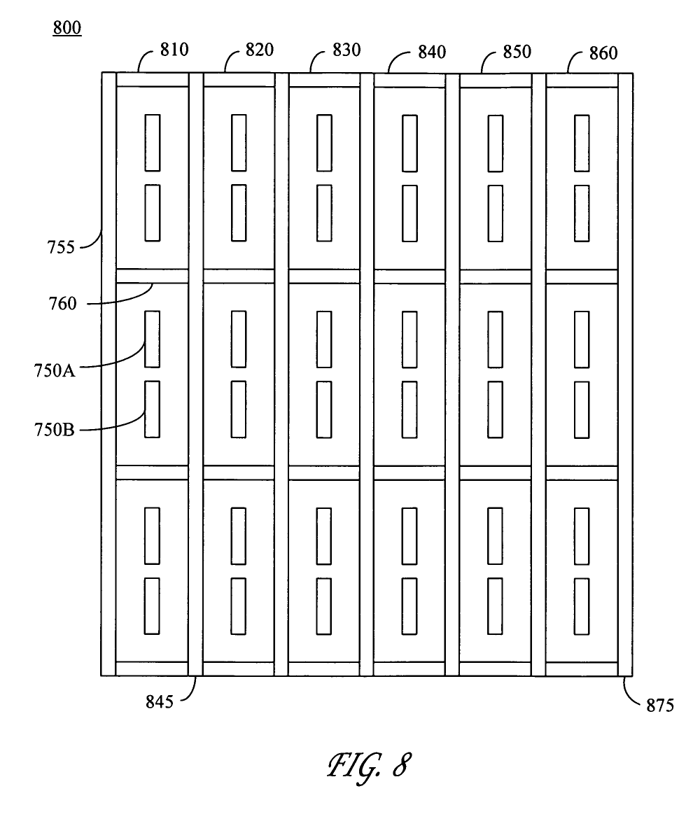

FIG. 7 depicts a second example arrangement of electrical contacts according to the invention as might be disposed along a length of an IMLA. As shown, the IMLA may include one or more differential signal pairs of electrical contacts S1+/S1−, S2+/S2−, S3+/S3−, one or more intermediate ground plates 760, one or more end ground plates 762, and one or more lateral ground plates 755. The lateral ground plate 755 may be electrically coupled to (e.g., in electrical contact with) the intermediate ground plates 760 and end ground plates 762. As shown in FIG. 8, a number of such IMLAs may be disposed adjacent to one another. Thus, a connector may be formed wherein a differential signal pair (e.g., pair 750A, 750B) may be surrounded by some combination of intermediate, lateral, and end ground plates.

FIG. 8 depicts an example embodiment of a connector contact array according to the invention. As shown in FIG. 8, the contact array 800 may include a first lateral ground plate 755, which may be part of a first lead assembly 810, and second lateral ground plate 845, which may be part of a second lead assembly 820. Thus, ground plate 845 may be used to shield the signal pairs in both lead frame assemblies 810 and 820. Leadframe assemblies 820, 830, 840, 850, and 860 are configured such that every signal pair is surrounded by a plurality of ground plates as shown. A lateral shield plate 875 may be added, as shown, to leadframe assembly 860 so that the signal pairs of that assembly are also surrounded by shield plates.

It is to be understood that the foregoing illustrative embodiments have been provided merely for the purpose of explanation and are in no way to be construed as limiting of the invention. Words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed:

1. An electrical connector, comprising:
first and second differential signal pairs, wherein each of the first and second differential signal pairs is edge-coupled along a first direction; and
an intermediate ground plate disposed adjacent to a respective electrical contact of each of the first and second differential signal pairs, the first ground plate extending along a direction that is different from the first direction.

2. The electrical connector of claim 1, further comprising:
a first lateral ground plate extending along the first direction, the first lateral ground plate in electrical contact with the intermediate ground plate.

3. The electrical connector of claim 2, further comprising a second lateral ground plate extending along the first direction, the second lateral ground plate in electrical contact with the intermediate ground plate.

4. The electrical connector of claim 3, wherein at least one of the first and second differential signal pairs is disposed between the first and second lateral ground plates.

5. The electrical connector of claim 1, further comprising:
an end ground plate disposed adjacent to an electrical contact of the first differential signal pair, the end ground plate extending along a direction that is different from the first direction.

6. The electrical connector of claim 5, wherein the first differential signal pair is disposed between the intermediate ground plate and the end ground plate.

7. The electrical connector of claim 1, wherein the intermediate ground plate extends along a direction that is transverse to the first direction.

8. An electrical connector, comprising:
a lead frame assembly comprising a differential signal pair of electrical contacts disposed along a first direction;
a plurality of ground plates, each of which is adjacent to at least one of the electrical contacts that form the differential signal pair, wherein the ground plates, in combination, surround the differential signal pair; and
a housing that contains the lead frame assembly.

9. The electrical connector of claim 8, wherein the ground plates shield the differential signal pair from electrical interference from an adjacent differential signal pair.

10. The electrical connector of claim 8, wherein the ground plates shield an adjacent differential signal pair from electrical interference from the differential signal pair.

11. An electrical connector, comprising:
a lead frame assembly comprising a first differential signal pair of electrical contacts disposed along a first contact column;
a ground plate assembly that surrounds the first differential signal pair,
wherein the ground plate assembly shields the first differential signal pair from electrical interference from an adjacent differential signal pair.

12. The electrical connector of claim 11, wherein the adjacent differential signal pair is disposed along the first contact column.

13. The electrical connector of claim 11, wherein the adjacent differential signal pair is disposed along a second contact column that is adjacent to the first contact column.
